(19) United States
(12) Patent Application Publication
(10) Pub. No.: US 2016/0072152 A1
(43) Pub. Date: Mar. 10, 2016

(54) LITHIUM ION SECONDARY BATTERY

(71) Applicant: HITACHI, LTD., Tokyo (JP)

(72) Inventors: Shigetaka TSUBOUCHI, Tokyo (JP); Seogchul SHIN, Tokyo (JP)

(73) Assignee: HITACHI, LTD., Tokyo (JP)

(21) Appl. No.: 14/829,846

(22) Filed: Aug. 19, 2015

(30) Foreign Application Priority Data
Sep. 5, 2014 (JP) 2014-180735

(51) Int. Cl. H01M 10/0569; H01M 4/133; H01M 4/38; H01M 4/48; H01M 4/36; H01M 10/0525; H01M 4/587

(52) U.S. Cl. CPC H01M 10/0569; H01M 10/0525; H01M 4/133; H01M 4/587; H01M 4/48; H01M 4/364; H01M 4/38; H01M 2004/027

(57) ABSTRACT

Provided is a lithium ion secondary battery including a positive electrode, a negative electrode, and an electrolyte solution, in which the electrolyte solution contains a compound represented by the following Formula (1). The negative electrode includes a graphite negative electrode active material and a Si composite material. The Si composite material is a particle which is formed of a matrix including an oxidized Si or a Si alloy, and a Si crystallite has a size of 50 nm or less which is dispersed in the matrix.

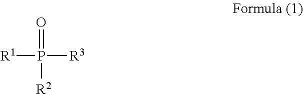

(where R¹, R², and R³ each represent an alkyl group having 1 to 2 carbon atoms or an alkoxyl group having 1 to 2 carbon atoms.) Thus, expansion and contraction of the Si material can be suppressed, as well as co-insertion of the phosphate and lithium ions into graphite in the lithium ion battery including the phosphate can be minimized.

### CLAIM OF PRIORITY

The present application claims priority from Japanese Patent application serial No. 2014-180735, filed on Sep. 5, 2014, the content of which is hereby incorporated by reference into this application.

### BACKGROUND OF THE INVENTION

1. Field of the Invention

The present invention relates to a lithium ion secondary battery.

2. Description of the Related Art

For lithium ion secondary batteries, the increased power and increased energy density have been required for applications as typified by automobiles, aircraft, and mobile devices. In recent years, for further increasing the energy density, negative electrodes are used in which Si with a high theoretical capacity of 4200 mAh/g is mixed in addition to conventional graphite with a theoretical capacity of 372 mAh/g. However, in most of the lithium ion secondary batteries, a flammable non-aqueous electrolyte solution is used which is composed of a mixed solvent of a cyclic carbonate and a chain carbonate and lithium hexafluorophosphate (LiPF₆) as an electrolyte salt.

With increasing energy of the lithium ion secondary batteries, flame-retardant electrolyte solutions have been required for the purpose of safety improvements.

In JP-2002-280061-A and JP-2001-185210-A, an electrolyte solution is applied which contains a phosphate as a flame-retardant solvent.

JP-2008-282819-A discloses a technique that relates to a compound including a Si phase, SiO₂, and a carbon material.

### SUMMARY OF THE INVENTION

Provided is a lithium ion secondary battery including a positive electrode, a negative electrode, and an electrolyte solution, in which the electrolyte solution contains a compound represented by the following Formula (1), the negative electrode includes a graphite negative electrode active material and a Si composite material, and the Si composite material is a particle which is formed of a matrix including an oxidized Si or a Si alloy, and a Si crystallite has a size of 50 nm or less which is dispersed in the matrix.

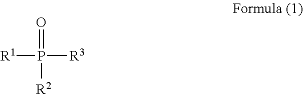

(where R¹, R², and R³ each represent an alkyl group having 1 to 2 carbon atoms or an alkoxyl group having 1 to 2 carbon atoms.)

The change in the structure of the carbon material which has a graphene structure can be reduced by mixing the Si crystallite of 50 nm or less and the Si composite material which has a matrix structure, in addition to the graphite negative electrode.

According to the present invention, expansion and contraction of the Si material can be suppressed, as well as co-insertion of the phosphate and lithium ions into graphite in the lithium ion battery including the phosphate can be minimized.

### BRIEF DESCRIPTION OF THE DRAWINGS

FIG. 1 is a schematic cross-sectional view showing an internal structure of a lithium ion secondary battery.

### DESCRIPTION OF THE PREFERRED EMBODIMENTS

The electrolyte solution containing a solvent and a phosphate such as trimethyl phosphate, mentioned in JP-2002-280061-A and JP-2001-185210-A interact strongly with Li⁺ coming and going between a positive electrode and a negative electrode. That is, the electrolyte solution shows a solvation with Li⁺. And the phosphate and the lithium ions thus form a stable complex in the electrolyte solution. Even when the lithium ions penetrate into the graphite of the negative electrode, there is possibility that the phosphate and lithium ions are co-inserted into the negative electrode because the complex structure is unlikely to be collapsed. As a result, the complex collapses the structure of the negative electrode active material, and thereby the battery may fail to ensure its performance.

In the negative electrode active material including a Si phase, SiO₂ and a carbon material disclosed in JP-2008-282819-A, the phosphate and the lithium ions are also co-inserted into the Si. Thus, the co-insertion into the carbon can be suppressed and degradation of the negative electrode can be somewhat suppressed. However, based on a comparison between Si and carbon, the Si has a higher resistance, thus the lithium ions are inserted into the carbon first in the insertion of lithium ions into the negative electrode. Accordingly, the co-insertion of the phosphate and the lithium ions into the carbon still has a significant influence, which becomes problematic. Moreover, the co-insertion of the phosphate and the lithium ions into the Si material leads to expansion and contraction of the negative electrode.

An object of the present invention is to suppress expansion and contraction of a Si material, as well as to minimize the co-insertion of the phosphate and the lithium ions into the graphite in the lithium ion battery.

Embodiments of the present invention will be described below with reference to the accompanying drawing. The following description is intended to provide specific examples of the subject matter of the present invention, but the present invention is not to be considered limited to the description, and various changes and modifications can be made by one skilled in the art within the scope of the technical idea disclosed in this specification. In addition, throughout the drawing for explaining the present invention, elements that have identical functions are denoted by identical reference symbols, and repeated descriptions thereof may be omitted.

<Lithium Ion Secondary Battery>

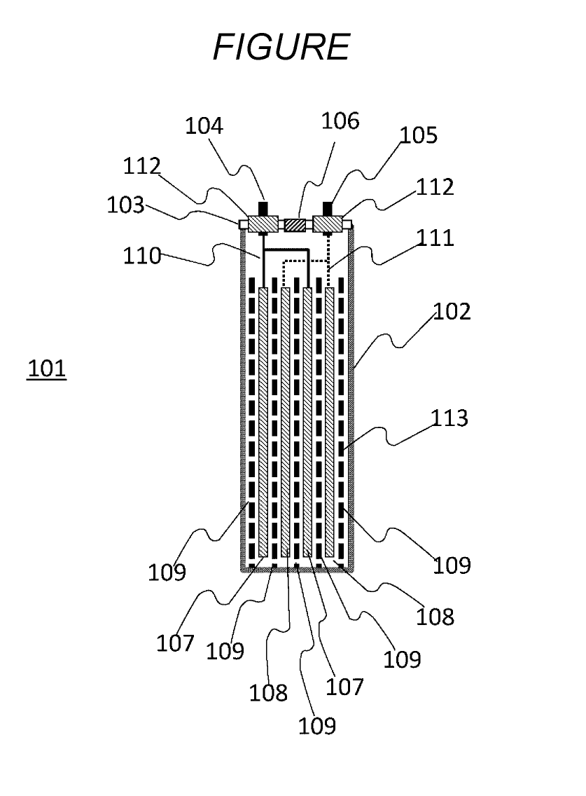

FIG. 1 schematically shows an internal structure of a lithium ion secondary battery 101. The lithium ion secondary battery 101 is a generic term referring to an electrochemical device that allows for storage and use of electrical energy through storage and release of ions to and from electrodes in a non-aqueous electrolyte. In the present embodiment, a lithium ion secondary battery will be described as a typical example.

The lithium ion secondary battery 101 in FIG. 1 has an electrode group composed of positive electrodes 107, negative electrodes 108, and separators 109 inserted between the both types of electrodes, which is housed in a battery container 102 in a hermetically sealed manner. The battery container 102 has, at the top thereof, a lid 103, and the lid 103 has a positive electrode external terminal 104, a negative electrode external terminal 105, and an injection port 106. After housing the electrode group in the battery container 102, the lid 103 is put over the battery container 102, and the periphery of the lid 103 is welded and integrated with the battery container 102.

At least one of the positive electrodes 107 or negative electrodes 108 is stacked alternately on one another, and the separator 109 is inserted between the positive electrode 107 and the negative electrode 108 to prevent short circuit between the positive electrode 107 and the negative electrode 108. The positive electrode 107, the negative electrode 108, and the separator 109 constitute the electrode group. It is possible to use the separator 109 of, e.g., a polyolefin polymer sheet composed of polyethylene, polypropylene, or the like, or a multi-layer structure of a polyolefin polymer welded with a fluorinated polymer sheet typified by polyethylene tetrafluoride. In order to prevent shrinkage of the separator 109 when the battery temperature is increased, a mixture of a ceramic and a binder may be formed in the form of a thin layer on the surface of the separator 109. These types of separators 109 are able to be used for the lithium ion secondary battery 101 typically as long as the separators are 0.01 μm to 10 μm in pore size and 20% to 90% in porosity, because the separators require lithium ion permeation when the lithium ion secondary battery 101 is charged or discharged.

The separator 109 is also inserted between the electrode placed at an end of the electrode group and the battery container 102, so as to keep the positive electrode 107 and the negative electrode 108 from short-circuiting through the battery container 102. On the surfaces of the separators 109, positive electrodes 107, and negative electrodes 108, and within the pores, an electrolyte solution 113 is retained.

The top of the electrode group is electrically connected to external terminals through leads. The positive electrodes 107 are connected to the positive electrode external terminal 104 through a positive electrode lead 110. The negative electrodes 108 are connected to the negative electrode external terminal 105 through a negative electrode lead 111. It is to be noted that the positive electrode lead 110 and the negative electrode lead 111 may have any shape such as in the form of a wire or a plate. The positive electrode lead 110 and the negative electrode lead 111 have any shape and material, as long as the leads have a structure that can reduce the ohmic loss when an electric current is applied, and have a material that is not reactive with the electrolyte solution 113.

Between the positive electrode external terminal 104 or the negative electrode external terminal 105 and the battery container 102, an insulating seal material 112 is inserted so as to keep both of the terminals from being short-circuited. The insulating seal material 112 can be selected from among fluorine resins, thermosetting resins, glass hermetic seal, and the like, and have use of any material that is not reactive with the electrolyte solution 113, but excellent in airtightness.

When a current interruption mechanism that makes use of a resistor element of positive temperature coefficient (PTC) is provided in the middle of the positive electrode lead 110 or the negative electrode lead 111, or at the connection between the positive electrode lead 110 and the positive electrode external terminal 104 or the connection between the negative electrode lead 111 and the negative electrode external terminal 105, it becomes possible to stop charging or discharging the lithium ion secondary battery 101 for the protection of the battery, when the temperature within the battery is increased. It is to be noted that the positive electrode lead 110 and the negative electrode lead 111 may have any shape such as in the form of foil or a plate.

The structure of the electrode group may have various shapes such as strip electrodes stacked as shown in FIG. 1, or electrodes rolled in any shape such as a cylindrical shape or a flattened shape. For the shape of the battery container, shapes such as a cylindrical shape, an oblate shape, and an angular shape may be selected in accordance with the shape of the electrode group.

The material of the battery container 102 is selected from materials that are corrosion-resistant to non-aqueous electrolytes, such as aluminum, stainless steels, and nickel-plated steels. Furthermore, when the battery container 102 is electrically connected to the positive electrode lead 110 or the negative electrode lead 111, the material of the lead is selected so as not to cause an alteration of the material due to the battery container corroded or alloyed with lithium ions at a part of the lead in contact with a non-aqueous electrolyte.

Thereafter, the lid 103 is closely attached to the battery container 102 to hermetically seal the whole battery. Methods for hermetically sealing the battery include known techniques such as welding and swaging.

<Positive Electrode>

The positive electrode 107 is composed of a positive electrode mixture layer and a positive electrode current collector. The positive electrode mixture layer is composed of a positive electrode active material, and if necessary, a conducting agent and a binder. Typical examples of the positive electrode active material include LiCoO₂, LiNiO₂, and LiMn₂O₄. In addition, it is possible to list LiMnO₂, LiMn₂O₂, LiMnO₂, Li₄Mn₅O₁₂, LiMn₂₋ₓMₓO₂ (where M=Co, Ni, Fe, Cr, Zn, Ta, x=0.01 to 0.2), Li₂Mn₃MO₈ (where M=Fe, Co, Ni, Cu, Zn), Li₁₋ₓAxMn₂O₄ (where A=Mg, Ba, B, Al, Fe, Co, Ni, Cr, Zn, Ca, x=0.01 to 0.1), LiNi₁₋ₓMxO₂ (where M=Co, Fe, Ga, x=0.01 to 0.2), LiFeO₂, Fe₂(SO₄)₃, LiCo₁₋ₓMₓO₂ (where M=Ni, Fe, Mn, x=0.01 to 0.2), LiNi₁₋ₓMₓO₂ (where M=Mn, Fe, Co, Al, Ga, Ca, Mg, x=0.01 to 0.2), Fe(MoO₄)₃, FeF₃, LiFePO₄, and LiMnPO₄. The present invention is not restricted in terms of positive electrode material in any way, thus not limited to these materials.

The particle size of the positive electrode active material is specified so as to be equal to or less than the thickness of the positive electrode mixture layer. When the positive electrode active material powder has therein coarse particles equal to or more than the thickness of the positive electrode mixture layer in size, the coarse particles are removed in advance by sieve classification, air flow classification, or the like to prepare particles equal to or less than the thickness of the positive electrode mixture layer.

The positive electrode active material, which is a powder, thus requires a binder for binding the particles of the powder to each other in order to provide a positive electrode. In addition, when the positive electrode active material is an oxide, a carbon powder is added to increase the conductivity between oxide particles, because oxides are generally low in conductivity.

The positive electrode active material, the conducting agent, and the binder are blended so that the positive electrode active material, the conducting agent, and the binder are respectively 80 mass % to 95 mass %, 3 mass % to 15 mass %, and 1 mass % to 10 mass % in mixture ratio (expressed in percentage by mass). In order to adequately offer conductivity, and allow for large current charge and discharge, the conducting agent is desirably adjusted to 5 mass % or more in mixture ratio. This is because the resistance of the whole positive electrode is reduced, thereby resulting in a reduced ohmic loss even when a large current is applied. On the other hand, in the case of increasing the energy density of the battery, the positive electrode active material is desirably adjusted to fall within a higher range of 85 mass % to 95 mass % in mixture ratio.

For the conducting agent, known materials can be used such as graphite, amorphous carbon, graphitizable carbon, carbon black, e.g., Denka Black, activated carbon, carbon fibers, and carbon nanotubes. Conductive fibers include vapor-grown carbon, fibers produced by carbonization of pitch (by-products from oils, coals, coal tar) as raw materials at high temperatures, and carbon fibers produced from acrylic fibers (Polyacrylonitrile). In addition, fibers may be used which are composed of metallic materials that are not oxidized or dissolved at the charge-discharge potential (typically 2.5 V to 4.3 V) of the positive electrode, but lower in electrical resistance than the positive electrode active material, for example, anticorrosion metals such as titanium and gold, carbides such as SiC and WC, and nitrides such as Si₃N₄ and BN. For the production methods, existing production methods can be used, such as melting methods and chemical vapor deposition methods.

Aluminum foil of 10 μm to 100 μm in thickness, perforated aluminum foil of 10 μm to 100 μm in thickness and 0.1 mm to 10 mm in pore size, an expanded metal, a foamed metal plate, or the like is used for the positive electrode current collector, and as for the material, it is also possible to apply stainless steels, titanium, and the like, besides aluminum. In the present invention, any current collector can be used without being limited by the material, shape, production method, or the like thereof.

For the application of the positive electrode 107, known production methods can be adopted, such as a doctor blade method, a dipping method, and a spray method, and there is not a limit on the means for the application. In addition, the positive electrode 107 can be prepared by attaching slurry to the current collector, then drying the organic solvent, and subjecting the positive electrode to pressing with a roll press. In addition, it is also possible to laminate more than one mixture layer on the current collector by performing the procedure from the application to the drying more than once.

<Negative Electrode>

The negative electrode 108 is composed of a negative electrode mixture layer and a negative electrode current collector. The negative electrode mixture layer is mainly composed of a negative electrode active material and binder, and if necessary, a conducting agent may be added in some cases.

As the negative electrode active material, a graphite negative electrode active material can be used. Carbon materials that generally have a graphene structure, carbonaceous materials such as natural graphite, artificial graphite, mesophase carbon, expanded graphite, carbon fibers, vapor-grown carbon fibers, pitch-based carbonaceous materials, needle coke, petroleum coke, polyacrylonitrile carbon fibers, and carbon black, which are able to electrochemically store and release lithium ions, or amorphous carbon materials synthesized by pyrolysis from five-membered or six-membered cyclic hydrocarbon or cyclic oxygen-containing organic compounds can be used as the graphite negative electrode active material. Furthermore, conductive polymer materials of polyacene, polyparaphenylene, polyparaphenylene, polyaniline, and polyacetylene can be combined with carbon materials that have a graphene structure, such as graphite, graphitizable carbon, and non-graphitizable carbon.

However, when the negative electrode active material described above is combined with a phosphate electrolyte solution, there is a possibility that the structure of the negative electrode will be collapsed. Phosphate electrolyte solutions interact strongly (solvation) with Li⁺ coming and going between the positive electrode and the negative electrode, and the phosphates and lithium ions thus form stable complexes in the electrolyte solutions. Even when lithium ions penetrate into graphite of the negative electrode, the complex structure is unlikely to be collapsed, and there is thus possibility that the phosphate and lithium ions will be co-inserted into the negative electrode to collapse the structure of the negative electrode active material, thereby resulting in failure to ensure battery performance.

In the present invention, the change in the structure of the carbon material which has a graphene structure can be reduced by mixing a Si composite material in a matrix form, in addition to the above-mentioned carbon material which has a graphene structure.

For example, materials of Si crystals in oxidized Si or a Si alloy matrix can be used as the Si composite material in a matrix form. The Si crystals in the matrix form can suppress expansion or contraction due to charge or discharge. Materials for the oxidized Si include SiO₂, SiO, Si, SnSiO₃, MnSiO₃, FeSiO₃, Li₂TiSiO₃, and ZnSiO₃. SiO₂ is more preferred in that it reacts with Li to change into lithium silicate such as Li₄SiO₄ during initial charge, and the lithium silicate which is a favorable Li ion conductor acts as a transfer path for Li ions.

This matrix phase serves importantly to reduce expansion and contraction of Si, but on the other hand, has a higher resistance as compared with a single element Si, and can constitute a factor of increase in battery overvoltage. Therefore, the ratio between a crystallite Si and the matrix of oxidized Si material, the crystal size of Si, the size of the Si composite material, and the proportions of the graphite negative electrode active material and Si composite material are important in order to reduce the change in the structure of the carbon material which has a graphene structure, and suppress expansion or contraction of the active material due to charge or discharge. It is to be noted that, for example, the Si composite material of the crystallite Si and the matrix SiO₂ herein is expressed in the form of SiOₓ (0.2≦x≦1), in order to clearly express the quantitative relationship.

As for the composition of the crystallite Si and the matrix of oxidized Si material, the molar ratio of Si:oxidized Si material is desirably 50:50 to 90:10, more desirably, 60:40 to 80:20 in a preferred form.

A size of the crystallite Si is 50 nm or less, and more preferably 20 nm or less from the perspective of ensuring dispersibility into the matrix and conductivity. Furthermore, the size is preferably 1 nm or more in terms of reactivity. In addition, the “size of the crystallite Si” means a crystallite diameter (an average value) of Si described below.

The proportion of Si composite material in the negative electrode is preferably 30 mass % or more with respect to the total amount of the graphite negative electrode active material and Si composite material. When the proportion of the Si composite material is 30 mass % or less, the proportion of lithium ions inserted into the graphite negative electrode active material is increased in an early stage of charge, and there is a possibility of increasing the probability that co-insertion of an electrolyte solution compound such as TMP and Li will collapse the structure of the graphite negative electrode active material.

In addition, the Si composite material is preferably 200 nm or more and 5 μm or less. When the size of the Si composite material is excessively large with respect to the Si crystallite, Li ions are less likely to reach the central part of the Si composite material, which may cause an increase in resistance.

As the Si alloy, an alloy of a metal element M alloyed with Si can be used, which is expressed as SiM. For example, any of Al, Ni, Cu, Fe, Ti, and Mn, or a combination thereof can be used as the metal element M alloyed with Si.

The method of preparing the Si alloy can involve mechanical synthesis by a mechanical alloying method, or heating and cooling a mixture of Si particles and other metal element.

In addition, the size of the crystallite can be adjusted, for example, depending on the method of heating, in particular, by temperature control.

For example, the size of the crystallite is reduced by setting a lower temperature.

As for the composition of the Si alloy, the molar ratio of Si:other metal element is desirably 50:50 to 90:10, more desirably, 60:40 to 80:20 in a preferred form. Furthermore, the Si composite material of the crystallite Si and matrix of Si alloy, for example, the composite material of Si and an Si-M alloy is expressed in the form of SiₓM₁₋ₓ (0.5≦x≦0.9), in order to clearly express the quantitative relationship.

The mixture composed of: the mixed negative electrode active material of the carbon material which has a graphene structure and the Si-based negative electrode in the matrix form; a binder; and a conductive material can be, with the addition of a solvent thereto, sufficiently kneaded or dispersed to prepared slurry. The slurry can be applied to a current collector to produce the negative electrode. The solvent can be arbitrarily selected as long as the binder in the present invention is not altered by the solvent such as organic solvents and water.

The mixture ratio between the negative electrode active material and the binder preferably falls within the range of 80:20 to 99:1 in terms of ratio by mass. In order to adequately offer conductivity, and allow for large current charge and discharge, the composition by mass is desirably adjusted to have a smaller value in the proportion of the negative electrode active material relative to 99:1. On the other hand, in order to increase the energy density of the battery, it is preferable to provide the composition so that the proportion of the negative electrode active material is higher than 90:10.

If necessary, a conducting agent is added to the negative electrode. For example, in the case of large current charge or discharge, it is preferable to lower the resistance of the negative electrode by adding a small amount of conducting agent. For the conducting agent, known materials can be used such as graphite, amorphous carbon, graphitizable carbon, carbon black, activated carbon, carbon fibers, and carbon nanotubes. Conductive fibers include vapor-grown carbon, fibers produced by carbonization of pitch (by-products from oils, coals, coal tar) as raw materials at high temperatures, and carbon fibers produced from acrylic fibers (Polyacrylonitrile).

The negative electrode 108 is produced by applying the slurry mentioned above to the negative electrode current collector and evaporating the solvent for drying. Copper foil of 10 μm to 100 μm in thickness, perforated copper foil of 10 μm to 100 μm in thickness and 0.1 mm to 10 mm in pore size, expanded metal, a foamed metal plate, or the like is used for the negative electrode current collector, and as for the material, it is also possible to apply stainless steels, titanium, and the like, besides copper. In the present invention, any current collector can be used without being limited by the material, shape, production method, or the like thereof.

For the application of the negative electrode 108, known production methods can be adopted, such as a doctor blade method, a dipping method, and a spray method, and there is not a limit on the means for the application. In addition, the negative electrode 108 can be prepared by attaching the negative electrode slurry to the current collector, then drying the solvent, and subjecting the negative electrode to pressing with a roll press. In addition, it is also possible to laminate more than one negative electrode mixture layer on the current collector by performing the procedure from the application to the drying more than once.

<Electrolyte Solution>

In an electrolyte solution according to an embodiment of the present invention, an organic solvent, an electrolyte solution, and an additive are contained, in particular, on the premise that a phosphate solvent is used as a flame-retardant solvent.

<Organic Solvent>

Examples of the flame-retardant solvent include phosphate solvents, which are compounds represented by the following Formula (1).

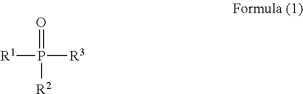

where R¹, R², and R³ each represent an alkyl group having 1 to 2 carbon atoms or an alkoxyl group having 1 to 2 carbon atoms. At least two of R¹, R², and R³ preferably represent the alkoxyl group having 1 to 2 atoms independently from each other, and for example, a methoxyl group is preferred as the alkoxyl group.

Furthermore, in the Formula (1), more preferably, all of R¹, R², and R³ represent the methoxyl group, or R¹ and R² represent the methoxyl group, whereas R³ represents a methyl, in that there is no damage to the solubility of Li salts or the flame retardant capability. In the present invention, the terms “C₁ to C₂ alkyls” and “C₁ to C₂ alkoxyls” mean unsubstituted groups, and specifically represent any of a methyl group, an ethyl group, a methoxy group, and an ethoxy group.

For example, trimethyl phosphate (TMP) or dimethyl methylphosphonate (DMMP) is preferred as a compound represented by the Formula (1). The compound represented by the Formula (1) is less flammable as compared with one or more additional organic solvents as described below. Therefore, the compound represented by the Formula (1) can be used as a flame retardant in the electrolyte solution for the lithium ion secondary battery according to the present invention. In addition, the compound represented by the Formula (1) has a larger number of donors as compared with one or more additional organic solvents as described below. Furthermore, the electrolyte has higher solubility in the compound represented by the Formula (1), as compared with fluorinated phosphorus compounds such as fluorine-containing phosphate. Therefore, the compound represented by the Formula (1) can dissolve a desired amount of electrolyte, even when the compound is not mixed with other organic solvent, but used alone as an organic solvent.

The organic solvent may be used in the form of only the compound represented by the Formula (1), or if desired, the compound represented by the Formula (1) may be used in the form of a mixture with one or more additional organic solvents (hereinafter, also referred to as a “mixed solution”). When the organic solvent is used in the form of the mixed solution, examples of the one or more additional organic solvents can include cyclic carbonates commonly used in the art, for example, ethylene carbonate (EC) or propylene carbonate; chain (linear or branched) carbonates, for example, dimethyl carbonate, ethylmethyl carbonate (EMC), or diethyl carbonate; cyclic ethers, for example, tetrahydrofurane, 1,3-dioxolan; chain (linear or branched) ethers, for example, dimethoxyethane; cyclic esters, for example, γ-butyrolactone; and chain (linear or branched) esters, for example, methyl acetate or ethyl acetate. The one or more additional solvents are preferably selected from the group consisting of ethylene carbonate (EC), ethylmethyl carbonate (EMC), and propylene carbonate. The use of the one or more additional solvents can improve the solubility of the electrolyte in the organic solvent.

The content of the compound represented by the Formula (1) in the organic solvent is preferably up to 50 vol % with respect to the total volume of the organic solvent. Alternatively, in terms of safe for the battery, the content of the compound represented by the Formula (1) in the organic solvent preferably falls within the range of 15 to 50 vol % with respect to the total volume of the organic solvent, more preferably within the range of 30 to 50 vol %, and when the content of the compound represented by the Formula (1) in the organic solvent falls within the previously mentioned range, the solubility of the electrolyte in the organic solvent can be improved.

<Electrolyte>

In the electrolyte solution for a lithium ion secondary battery according to an embodiment of the present invention, the electrolyte desirably has one or more lithium salts selected from the group consisting of LiPF₆, LiBF₄, LiCF₃SO₃, LiN(SO₂F)₂, LiClO₄, LiCF₃CO₂, LiAsF₆, and LiSbF₆. The electrolyte is preferably LiPF₆. LiPF₆ has high ion conductivity, and high solubility in the organic solvent. Therefore, the use of LiPF₆ as the electrolyte can improve battery characteristics (for example, charge-discharge characteristics) of the resultant lithium ion secondary battery.

In the electrolyte solution for a lithium ion secondary battery according to an embodiment of the present invention, the electrolyte is preferably contained at a concentration of at least 0.5 mol/L (mol·dm⁻³). The concentration refers to a molar concentration with respect to the total volume of the electrolyte solution. The concentration of the electrolyte preferably falls within the range of 0.5 to 2 mol/L, more preferably within the range of 0.5 to 1.5 mol/L, and particularly preferably within the range of 0.5 to 1 mol/L. The electrolyte contained at the concentration can improve battery characteristics (for example, charge-discharge characteristics) of the resultant lithium ion secondary battery.

<Additive>

In addition to the previously described electrolyte, an additive can be contained which includes an alkali metal salt or an alkaline-earth metal salt. Examples of the alkali metal salt or alkaline-earth metal salt include an alkali metal ion or an alkaline-earth metal ion (cation) other than lithium, such as, for example, Na⁺, Mg²⁺, Ca²⁺, Sr²⁺, Ba²⁺, K⁺, Rb⁺, and Cs⁺. The following: Br⁻, I⁻, PF₆⁻, BF₄⁻, ClO₄⁻, SO₃CF₃⁻, N(SO₂F)₂⁻, N(SO₂CF₃)₂⁻, or N(SO₂CF₂CF₃)₂⁻ is selected as the counter anion for the metal cation. Above all, Ca(N(SO₂CF₃)₂)₂, Mg(N(SO₂CF₃)₂)₂, or KN(SO₂CF₃)₂ is desired in terms of solubility in the electrolyte solution.

In the electrolyte solution for a lithium ion secondary battery according to an embodiment of the present invention, the additive is preferably contained at a concentration of at least 0.05 mol/L (mol·dm⁻³). The concentration refers to a molar concentration with respect to the total volume of the electrolyte solution. The concentration of the additive preferably falls within the range of 0.05 to 1 mol/L, more preferably within the range of 0.05 to 0.5 mol/L, and particularly preferably within the range of 0.05 to 0.1 mol/L. The additive contained at the concentration in the previously listed range can substantially suppress the formation of solvated molecules of lithium ions of the electrolyte with the compound represented by the Formula (1) to improve battery characteristics (for example, charge-discharge characteristics) of the lithium ion secondary battery.

The present invention will be further specifically described below with reference to examples. The following examples show examples of constant current charge to 0.005 V with a current value of 3.5 mA/cm², followed by constant voltage charge at 0.005 V, completion of the charge after convergence of the current value to 0.035 mA/cm² or a lapse of 5 hours, and discharge to 1.5 V with a current value of 3.5 mA/cm² in a battery structure with graphite or a mixed negative electrode composed of graphite and Si as a working electrode and with Li metal as a counter electrode and a reference electrode, and the charge/discharge efficiency effects thereof.

The ignition test on liquids shows results of filling a stainless-steel container of 2 cm in inside diameter and 1 cm in depth with the electrolyte solution, and toasting the surface of the solution for 5 seconds with a gas burner.

A crystallite diameter of Si was calculated with the use of the Scherrer equation and an X-ray diffraction pattern. The value of the average particle diameter D50 obtained by a laser-diffraction particle size distribution measurement device was used as the particle size of Si in the matrix of oxidized Si material or Si alloy material.

TABLE 1

| | Si | | | Charge/ |
|---|---|---|---|---|
| | Crystallite | Particle | Si | Discharge |
| | Diameter | Diameter | Content | Efficiency |
| | nm | μm | mass % | % |
| Comparative | — | — | 0 | 1 |
| Example 1 | | | | |
| Comparative | | | | |
| Example 2 | — | 5 | 30 | 21 |
| Example 1 | 20 | 3 | 30 | 61 |

### Comparative Example 1

The electrolyte solution is a solution of 1.0 mol·dm⁻³ of LiPF₆ dissolved in a mixed solvent composed of EC, EMC, and TMP at a volume ratio of 16.7:33.3:50. A negative electrode is formed of a negative electrode active material consisting of graphite. A battery was produced by these components, and subjected to the measurements. Table 1 shows a result of an initial charge/discharge efficiency.

### Comparative Example 2

The electrolyte solution is a solution of 1.0 mol·dm⁻³ of LiPF₆ dissolved in a mixed solvent composed of EC, EMC, and TMP at a volume ratio of 16.7:33.3:50. A negative electrode is formed of an active material consisting of graphite and Si of 5 μm in particle diameter at a mixture ratio of 70:30 by mass. A battery was produced by these components, and subjected to the measurements. The Si particles in this case are pure Si particles without any SiO₂ matrix. The result is shown in Table 1.

It is to be noted that in Table 1, the term “Particle Diameter” refers to the diameter of a particle including Si, whereas the “Si Crystallite Diameter” refers to the crystal particle diameter of Si in the particle including Si. In Comparative Example 2, due to the use of the pure Si particles without any SiO₂ matrix, the diameter of the particles is listed as the “Particle Diameter”. In addition, the Si content refers to the ratio of the Si particles by mass (mass %) to the total amount of the graphite and Si particles.

### Example 1

In this example, a negative electrode active material is used, consisting of graphite and Si composite material. The Si composite material includes a SiO₂ matrix and Si crystallites dispersed in the SiO₂ matrix, and has 20 nm in the Si crystallite diameter (an average value) and 3 μm in a secondary particle diameter (the particle diameter (an average value)). The graphite and the Si composite material are mixed at a mixture ratio of 70:30 by mass. An electrolyte solution is used which is a solution of 1.0 mol·dm⁻³ of LiPF₆ dissolved in a mixed solvent composed of EC, EMC, and TMP at a volume ratio of 16.7:33.3:50.

Table 1 shows a result of the initial charge/discharge efficiency in a battery produced by these components.

From Example 1 and Comparative Examples 1 and 2, it has been confirmed that the charge/discharge efficiency is improved by reducing the Si crystallite diameter to a smaller particle size of 20 nm, as compared with the conditions of: only graphite; and the Si of 5 μm in the particle diameter, in the case of the solution of 1.0 mol·dm⁻³ of LiPF₆ dissolved in the mixed solvent composed of EC, EMC, and TMP at a volume ratio of 16.7:33.3:50.

TABLE 2

| | | Si | Charge/ |
|---|---|---|---|
| | | Content | Discharge |
| | Si + Si | mass | Efficiency |
| | Alloy | % | % |
| Example 2 | Si_{0.7}Al_{0.3} | 30 | 51 |
| Example 3 | Si_{0.7}Ni_{0.3} | 30 | 55 |
| Example 4 | Si_{0.7}Cu_{0.3} | 30 | 60 |
| Example 5 | Si_{0.7}Fe_{0.3} | 30 | 55 |
| Example 6 | Si_{0.7}Ti_{0.3} | 30 | 65 |
| Example 7 | Si_{0.7}Mn_{0.3} | 30 | 53 |

### Example 2

In this example, a negative electrode active material is used, consisting of graphite and Si composite material. The Si composite material is formed of a Si_{0.7}Al_{0.3} alloy. The Si composite material consists of a Si—Al alloy matrix and a crystallite of Si dispersed in the Si—Al alloy matrix. The Si composite material is produced by a mechanical alloying method. The crystallite of Si is 20 nm or less in the diameter, whereas the secondary particle of Si_{0.7}Al_{0.3} alloy is 3 μm in the diameter. The graphite and the Si composite material are mixed at a mixture ratio of 70:30 by mass. An electrolyte solution is used which is a solution of 1.0 mol·dm⁻³ of LiPF₆ dissolved in a mixed solvent composed of EC, EMC, and TMP at a volume ratio of 16.7:33.3:50.

Table 2 shows the result of the initial charge/discharge efficiency in a battery produced by these components.

### Example 3

In this example, a negative electrode active material is used, containing graphite and Si composite material. The Si composite material is formed of a Si_{0.7}Ni_{0.3} alloy. The Si composite material consists of a Si—Ni alloy matrix and a crystallite of Si dispersed in the Si—Ni alloy matrix. The Si composite material is produced by a mechanical alloying method. The crystallite of Si is 20 nm or less in the diameter, whereas the secondary particle of Si_{0.7}Ni_{0.3} alloy is 3 μm in the diameter. The graphite and the Si composite material are mixed at a mixture ratio of 70:30 by mass. An electrolyte solution is used which is a solution of 1.0 mol·dm⁻³ of LiPF₆ dissolved in a mixed solvent composed of EC, EMC, and TMP at a volume ratio of 16.7:33.3:50.

Table 2 shows the result of the initial charge/discharge efficiency in a battery produced by these components.

### Example 4

In this example, a negative electrode active material is used, containing graphite and Si composite material. The Si composite material is formed of a Si_{0.7}Cu_{0.3} alloy. The Si composite material consists of a Si—Cu alloy matrix and a crystallite of Si dispersed in the Si—Cu alloy matrix. The Si composite material is produced by a mechanical alloying method. The crystallite of Si is 20 nm or less in the diameter, whereas the secondary particle of Si_{0.7}Cu_{0.3} alloy is 3 μm in the diameter. The graphite and the Si composite material are mixed at a mixture ratio of 70:30 by mass. An electrolyte solution is used which is a solution of 1.0 mol·dm⁻³ of LiPF₆ dissolved in a mixed solvent composed of EC, EMC, and TMP at a volume ratio of 16.7:33.3:50.

Table 2 shows the result of the initial charge/discharge efficiency in a battery produced by these components.

### Example 5

In this example, a negative electrode active material is used, containing graphite and Si composite material. The Si composite material is formed of a Si_{0.7}Fe_{0.3} alloy. The Si composite material consists of a Si—Fe alloy matrix and a crystallite of Si dispersed in the Si—Fe alloy matrix. The Si composite material is produced by a mechanical alloying method. The crystallite of Si is 20 nm or less in the diameter, whereas the secondary particle of Si_{0.7}Fe_{0.3} alloy is 3 μm in the diameter. The graphite and the Si composite material are mixed at a mixture ratio of 70:30 by mass. An electrolyte solution is used which is a solution of 1.0 mol·dm⁻³ of LiPF₆ dissolved in a mixed solvent composed of EC, EMC, and TMP at a volume ratio of 16.7:33.3:50.

Table 2 shows the result of the initial charge/discharge efficiency in a battery produced by these components.

### Example 6

In this example, a negative electrode active material is used, containing graphite and Si composite material. The Si composite material is formed of a Si_{0.7}Ti_{0.3} alloy. The Si composite material consists of a Si—Ti alloy matrix and a crystallite of Si dispersed in the Si—Ti alloy matrix. The Si composite material is produced by a mechanical alloying method. The crystallite of Si is 20 nm or less in the diameter, whereas the secondary particle of Si_{0.7}Ti_{0.3} alloy is 3 μm in the diameter. The graphite and the Si composite material are mixed at a mixture ratio of 70:30 by mass. An electrolyte solution is used which is a solution of 1.0 mol·dm⁻³ of LiPF₆ dissolved in a mixed solvent composed of EC, EMC, and TMP at a volume ratio of 16.7:33.3:50.

Table 2 shows the result of the initial charge/discharge efficiency in a battery produced by these components.

### Example 7

In this example, a negative electrode active material is used, containing graphite and Si composite material. The Si composite material is formed of a Si_{0.7}Mn_{0.3} alloy. The Si composite material consists of a Si—Mn alloy matrix and a crystallite of Si dispersed in the Si—Mn alloy matrix. The Si composite material is produced by a mechanical alloying method. The crystallite of Si is 20 nm or less in the diameter, whereas the secondary particle of Si_{0.7}Mn_{0.3} alloy is 3 μm in the diameter. The graphite and the Si composite material are mixed at a mixture ratio of 70:30 by mass. An electrolyte solution is used which is a solution of 1.0 mol·dm⁻³ of LiPF₆ dissolved in a mixed solvent composed of EC, EMC, and TMP at a volume ratio of 16.7:33.3:50.

Table 2 shows the result of the initial charge/discharge efficiency in a battery produced by these components.

From Examples 2 to 7 and Comparative Example 2, it has been confirmed that the charge/discharge efficiency is improved even in the presence of the Si alloy matrix higher in resistance as compared with Si crystals, as compared with the conditions of: only graphite; and the Si primary particle diameter over 50 nm, in the solution of 1.0 mol·dm⁻³ of LiPF₆ dissolved in the mixed solvent composed of EC, EMC, and TMP at a volume ratio of 16.7:33.3:50.

TABLE 3

| | | SiO | Charge/ |
|---|---|---|---|
| | | Content | Discharge |
| | | mass | Efficiency |
| | Si + SiO₂ | % | % |
| Comparative | SiO | 10 | 5 |
| Example 3 | | | |
| Example 8 | SiO_{1.2} | 30 | 10 |
| Example 9 | SiO | 30 | 25 |

### Comparative Example 3

In this comparative example, a negative electrode active material is used, containing graphite and Si composite material. The Si composite material is formed of SiO. The Si composite material consists of a SiO₂ matrix and a crystallite of Si dispersed in the SiO₂ matrix. The crystallite of Si is 20 nm or less in the diameter, whereas the secondary particle of SiO is 5 μm in the diameter. The graphite and the Si composite material are mixed at a mixture ratio of 90:10 by mass. An electrolyte solution is used which is a solution of 1.0 mol·dm⁻³ of LiPF₆ dissolved in a mixed solvent composed of EC, EMC, and TMP at a volume ratio of 16.7:33.3:50.

Table 3 shows the result of the initial charge/discharge efficiency in a battery produced by these components.

### Example 8

In this example, a negative electrode active material is used, containing graphite and Si composite material. The Si composite material is formed of SiO_{1.2}. The Si composite material consists of a SiO₂ matrix and a crystallite of Si dispersed in the SiO₂ matrix. The crystallite of Si is 20 nm or less in the diameter, whereas the secondary particle of SiO_{1.2} is 5 μm in the diameter. The graphite and the Si composite material are mixed at a mixture ratio of 70:30 by mass. An electrolyte solution is used which is a solution of 1.0 mol·dm⁻³ of LiPF₆ dissolved in a mixed solvent composed of EC, EMC, and TMP at a volume ratio of 16.7:33.3:50.

Table 3 shows the result of the initial charge/discharge efficiency in a battery produced by these components.

### Example 9

In this example, a negative electrode active material is used, containing graphite and Si composite material. The Si composite material is formed of SiO. The Si composite material consists of a SiO₂ matrix and a crystallite of Si dispersed in the SiO₂ matrix. The crystallite of Si is 20 nm or less in the diameter, whereas the secondary particle of SiO is 5 μm in the diameter. The graphite and the Si composite material are mixed at a mixture ratio of 70:30 by mass. An electrolyte solution is used which is a solution of 1.0 mol·dm⁻³ of LiPF₆ dissolved in a mixed solvent composed of EC, EMC, and TMP at a volume ratio of 16.7:33.3:50.

Table 3 shows the result of the initial charge/discharge efficiency in a battery produced by these components.

From Examples 8 and 9 and Comparative Example 3, it has been confirmed that the charge/discharge efficiency is improved as long as the content of SiO is 30% or more with x of 1 or less in SiO in the negative electrode active material even under the condition of the Si primary particle of 20 nm or less, in the solution of 1.0 mol·dm⁻³ of LiPF₆ dissolved in the mixed solvent composed of EC, EMC, and TMP at a volume ratio of 16.7:33.3:50.

TABLE 4

| | The Amount | Charge/ | |
|---|---|---|---|
| | of TMP | Discharge | Solution |
| | Mixed | Efficiency | Ignition |
| | mass % | % | Test |
| Comparative | 100 | 0 | Not |
| Example 4 | | | Ignited |
| Comparative | 75 | 7 | Not |
| Example 5 | | | Ignited |
| Example 10 | 50 | 36 | Not |
| | | | Ignited |
| Example 11 | 30 | 55 | Self- |
| Comparative | | | Consuming |
| Example 6 | 15 | 72 | Self- |
| | | | Consuming |
| Comparative | 0 | 85 | Ignited |
| Example 7 | | | |

### Comparative Example 4

In this comparative example, a negative electrode active material is used, containing graphite and Si composite material. The Si composite material is formed of SiO. The Si composite material consists of a SiO₂ matrix and a crystallite of Si dispersed in the SiO₂ matrix. The crystallite of Si is 20 nm or less in the diameter, whereas the secondary particle of SiO is 5 μm in the diameter. The graphite and the Si composite material are mixed at a mixture ratio of 50:50 by mass. An electrolyte solution is used which is a solution of 1.0 mol·dm⁻³ of LiPF₆ dissolved in a solvent composed of TMP.

Table 4 shows the result of the ignition test of the electrolyte solution in a battery produced by these components.

### Comparative Example 5

In this comparative example, a negative electrode active material is used, containing graphite and Si composite material. The Si composite material is formed of SiO. The Si composite material consists of a SiO₂ matrix and a crystallite of Si dispersed in the SiO₂ matrix. The crystallite of Si is 20 nm or less in the diameter, whereas the secondary particle of SiO is 5 μm in the diameter. The graphite and the Si composite material are mixed at a mixture ratio of 50:50 by mass. An electrolyte solution is used which is a solution of 1.0 mol·dm⁻³ of LiPF₆ dissolved in a mixed solvent composed of EC, EMC, and TMP at a volume ratio of 8.3:16.7:75.

Table 4 shows the result of the ignition test of the electrolyte solution in a battery produced by these components.

### Example 10

In this example, a negative electrode active material is used, containing graphite and Si composite material. The Si composite material is formed of SiO. The Si composite material consists of a SiO₂ matrix and a crystallite of Si dispersed in the SiO₂ matrix. The crystallite of Si is 20 nm or less in the diameter, whereas the secondary particle of SiO is 5 μm in the diameter. The graphite and the Si composite material are mixed at a mixture ratio of 50:50 by mass. An electrolyte solution is used which is a solution of 1.0 mol·dm⁻³ of LiPF₆ dissolved in a mixed solvent composed of EC, EMC, and TMP at a volume ratio of 16.7:33.3:50.

Table 4 shows the result of the ignition test of the electrolyte solution in a battery produced by these components.

### Example 11

In this example, a negative electrode active material is used, containing graphite and Si composite material. The Si composite material is formed of SiO. The Si composite material consists of a SiO₂ matrix and a crystallite of Si dispersed in the SiO₂ matrix. The crystallite of Si is 20 nm or less in the diameter, whereas the secondary particle of SiO is 5 μm in the diameter. The graphite and the Si composite material are mixed at a mixture ratio of 50:50 by mass. An electrolyte solution is used which is a solution of 1.0 mol·dm⁻³ of LiPF₆ dissolved in a mixed solvent composed of EC, EMC, and TMP at a volume ratio of 23.3:46.7:30.

Table 4 shows the result of the ignition test of the electrolyte solution in a battery produced by these components.

### Comparative Example 6

In this comparative example, a negative electrode active material is used, containing graphite and Si composite material. The Si composite material is formed of SiO. The Si composite material consists of a SiO₂ matrix and a crystallite of Si dispersed in the SiO₂ matrix. The crystallite of Si is 20 nm or less in the diameter, whereas the secondary particle of SiO is 5 μm in the diameter. The graphite and the Si composite material are mixed at a mixture ratio of 50:50 by mass. An electrolyte solution is used which is a solution of 1.0 mol·dm⁻³ of LiPF₆ dissolved in a mixed solvent composed of EC, EMC, and TMP at a volume ratio of 28.3:56.7:15.

Table 4 shows the result of the ignition test of the electrolyte solution in a battery produced by these components.

### Comparative Example 7

In this comparative example, a negative electrode active material is used, containing graphite and Si composite material. The Si composite material is formed of SiO. The Si composite material consists of a SiO₂ matrix and a crystallite of Si dispersed in the SiO₂ matrix. The crystallite of Si is 20 nm or less in the diameter, whereas the secondary particle of SiO is 5 μm in the diameter. The graphite and the Si composite material are mixed at a mixture ratio of 50:50 by mass. An electrolyte solution is used which is a solution of 1.0 mol·dm⁻³ of LiPF₆ dissolved in a mixed solvent composed of EC and EMC at a volume ratio of 33.3:66.7.

Table 4 shows the result of the ignition test of the electrolyte solution in a battery produced by these components.

From Examples 10 and 11 and Comparative Examples 4 to 7, it has been confirmed that the amount of TMP that has a self-extinguishing function for the solution, the self-extinguishing function being necessarily required in order to ensure safety of the battery, and can ensure the charge/discharge efficiency is 15 to 50% under the condition of the Si primary particle of 20 nm or less in the solution of 1.0 mol·dm⁻³ of LiPF₆ dissolved in a mixed solvent composed of EC, EMC, and TMP.

It is to be noted that the present invention is not to be considered limited to the examples described above, but is considered to encompass various modification examples. For example, the examples described above are intended to describe the present invention in detail for clear explanations, but not necessarily to be considered limited to examples including all of the composition described. In addition, it is possible to replace a composition according to a certain example partially with a composition according to another example, and it is also possible to add a composition according to a certain example to a composition according to another example. In addition, for apart of the composition according to each example, it is possible to add, remove, or replace another composition. In particular, the positive electrode, the separator, or the battery structure is not to be considered limited as long as the battery composition includes: a negative electrode containing, as its main constituent, a carbon material capable of storing and releasing lithium ions; and the electrolyte solution specified in the embodiment.

What is claimed is:

1. A lithium ion secondary battery comprising:
a positive electrode;
a negative electrode; and
an electrolyte solution,
wherein the electrolyte solution contains a compound represented by the following Formula (1),
the negative electrode includes a graphite negative electrode active material and a Si composite material, and
the Si composite material is a particle formed of a matrix including an oxidized Si or a Si alloy, and a Si crystallite has a size of 50 nm or less dispersed in the matrix. 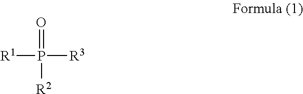
(In the formula, R¹, R², and R³ each represent an alkyl group having 1 to 2 carbon atoms or an alkoxyl group having 1 to 2 carbon atoms.)

2. The lithium ion secondary battery according to claim 1,
wherein the Si crystallite has the size of 1 nm or more and 20 nm or less.

3. The lithium ion secondary battery according to claim 2,
wherein the Si composite material is the particle having a size of 1 μm or more and 5 μm or less.

4. The lithium ion secondary battery according to claim 3,
wherein the Si composite material represents SiO (where x is in a range of 0.2≦x≦1.).

5. The lithium ion secondary battery according to claim 3,
wherein the oxidized Si material is any of SiO₂, SiO, Si, SnSiO₃, MnSiO₃, FeSiO₃, Li₂TiSiO₃, and ZnSiO₃.

6. The lithium ion secondary battery according to claim 3,
wherein the Si composite material is SiₓM₁₋ₓ (where x is in a range of 0.5≦x≦0.9, and M contains any one or more elements selected from the group consisting of Al, Ni, Cu, Fe, Ti, and Mn.).

7. The lithium ion secondary battery according to claim 6,
wherein the Si alloy is represented by SiM (where M contains any one or more elements selected from the group consisting of Al, Ni, Cu, Fe, Ti, and Mn.).

8. The lithium ion secondary battery according to claim 7,
wherein a proportion of the Si composite material in the negative electrode is 30 mass % or more to a total amount of the graphite negative electrode active material and the Si composite material.

9. The lithium ion secondary battery according to claim 8,
wherein the compound represented by the Formula (1) is 15 vol % to 50 vol % with respect to the electrolyte solution.

10. The lithium ion secondary battery according to claim 9,
wherein at least two of R¹, R², and R³ in the compound represented by the Formula (1) represent an alkoxyl group having 1 to 2 carbon atoms independently from each other.

11. The lithium ion secondary battery according to claim 10,
wherein the alkoxyl group is a methoxyl group.

12. The lithium ion secondary battery according to claim 11,
wherein R¹, R², and R³ in the compound represented by the Formula (1) each represent a methoxyl, or R¹ and R² each represent a methoxyl group and R³ represents a methyl group.
